(19) United States
(12) Patent Application Publication
(10) Pub. No.: US 2008/0146250 A1
(43) Pub. Date: Jun. 19, 2008

(54) Method and System for Creating and Using a Location Safety Indicator

(76) Inventor: Jeffrey Aaron, Atlanta, GA (US)

Correspondence Address: WITHERS & KEYS FOR BELL SOUTH, P. O. BOX 71355, MARIETTA, GA, 30007-1355, US

(21) Appl. No.: 11/611,517

(22) Filed: Dec. 15, 2006

(51) Int. Cl. H04Q 7/20

(52) U.S. Cl. 455/456.3

(57) ABSTRACT

Provided are exemplary embodiments including a method and system for electronically conveying information regarding a geographic location. While present at a geographic position, a user may want to disseminate information concerning an attribute of the location. The user may determine the geographic position with a wireless communication device and then create information on the wireless communication device describing the attribute of the geographic position. With the wireless communication device, the user electronically associates the information with the geographic position. The user then uploads the associated information from the wireless communication device to a server. A second user may then query the server about the geographic location and receive the data associated with that geographic location uploaded by other users.

### TECHNICAL FIELD

Embodiments are related to mobile communication devices. The subject matter described herein relates more particularly to a system and method allowing a user of a wireless communication device to associate and automatically retrieve information concerning a geographic location.

### BACKGROUND

The World is a dangerous place. However, the danger is not uniform and in many instances may not be readily apparent. Local governmental entities post warning signs as a traditional method to alert the populace about inherent danger. They also impose a duty on private entities to warn the populace about dangers that may exist on private property. However, these traditional mechanisms are applied inconsistently and at significant public and private expense. Thus, there is a continuing need to increase the personal safety of individuals and the populace in general.

Wireless communication devices are popular and ubiquitous devices amongst the general populace. The cost of wireless communication devices has plummeted and functionality has improved exponentially. As a result, most adults and an increasing number of children routinely carry a cell phone or other wireless communication device on their person out of convenience and as a safety measure. While away from home cell phone users like to be in communication with others, including 911 emergency response teams. However, the use of a cell phone as a means to summon help is a reactive safety measure. A cell phone may summon help only after a user has encountered a hazard. An omnipresent, inexpensive and user friendly means to associate, disseminate and retrieve information concerning a geographic position, while present at that location, currently does not exist.

### SUMMARY

While energized, wireless communication devices are continuously vigilant, constantly scanning a frequency for an indication of an incoming call. The omnipresence, vigilance and computing power of a wireless communication device can be leveraged to provide a method for associating a location with an indication of the safety level of that location for the wireless communication device user and for others. It should be appreciated that this Summary is provided to introduce a selection of these concepts in a simplified form that are further described below in the Detailed Description. This Summary is not intended to identify key features or essential features of the claimed subject matter, nor is it intended to be used to limit the scope of the claimed subject matter.

Provided are exemplary embodiments. The embodiments include a method for electronically conveying information regarding a geographic location with a wireless communication device that includes determining a geographic position of a location while present at the geographic position. The method further involves receiving an information input by the wireless communication device describing an attribute of the geographic position and electronically associating the information with the geographic position with the wireless communication device. The method then allows for uploading the associated information from the wireless communication device to a server.

Exemplary embodiments also include a central server within a network that includes a network interface and a processor that sends and receives associated geographic data via the network interface. The processor receives the associated geographic data from a first communication device and subsequently sends the associated geographic data to a second communication device upon receiving a request by the second communication device for the geographic data. The associated geographic data sent by the first communication device includes a geographic position that has been associated with information describing the geographic position.

In accordance with other exemplary embodiments, a computer readable medium is provided with instructions to perform acts that include electronically conveying information regarding a location. The instructions may further include acts determining the geographic position of the location with a wireless communication device and then creating information on the wireless communication device describing an attribute of the geographic position. The instructions may also include acts electronically associating the information with the geographic position by the wireless communication device and then uploading the associated information from the wireless communication device to a server within a network.

Other apparatuses, methods, and/or computer program products according to embodiments will be or become apparent to one with skill in the art upon review of the following drawings and Detailed Description. It is intended that all such additional systems, methods, and/or computer program products be included within this description, be within the scope of the present invention, and be protected by the accompanying claims.

### BRIEF DESCRIPTION OF THE DRAWINGS

FIG. 1 is an overview illustrating a system for creating and using a Location Safety Indicator utilizing a wireless communication device.

FIG. 2 depicts an example of a wireless communication device configured to associate information with a geographic position.

FIG. 3 depicts a network server that coordinates the associated information.

FIG. 4 is an exemplary flow chart demonstrating a method for creating and using a Location Safety Indicator using a wireless communication device.

FIG. 5 is an exemplary flow chart demonstrating a method for requesting a Location Safety Indicator using a wireless communication device.

FIG. 6 is an exemplary flow chart demonstrating the receipt of associated information by the central server.

FIG. 7 is an exemplary flow chart demonstrating the processing of a request for associated data from the central server

FIG. 8 is a depiction of a plurality of associated data records from a reporting user in the data base of the central server.

### DETAILED DESCRIPTION

The following disclosure is directed to an apparatus and methods allowing a user of a wireless communication device (“WCD”) to associate, disseminate and retrieve information concerning a geographic position. A WCD may be any wireless communication device. Non-limiting examples may include a cell phone, a PDA, a pager, an MP3 player, a miniaturized computer and the like.

In the following detailed description, references are made to the accompanying drawings that form a part hereof and which are shown, by way of illustration, using specific embodiments or examples. Referring now to the drawings, in which like numerals represent like elements through the several figures, aspects of the apparatus and methods provided herein will be described.

The use of WCDs has grown exponentially over the last decade. Today, most adults and an increasing number of children carry a WCD of some type or another. The most common WCD is the ubiquitous cell phone; however, there are millions of devotees to pagers, personal digital assistants (“PDA”) and other mobile devices. Technologies are also merging. For example MP3 players may be incorporated into cell phones and vice versa. Whatever the device, users of WCDs depend upon them to keep them connected to business, family and friends in an increasingly hectic world.

Throughout one's busy day, a user may encounter many different geographic locations under a plethora of environmental conditions. Conversely, some locations may be encountered by multitudes of people, such as a major traffic intersection or a business establishment. Other locations may be encountered by a relatively few people, such as a rural intersection. Each person encountering a specific location may perceive or associate some piece of information that would be valuable to share with others concerning the location. The information may be safety related, commercial or simply information of note.

In these situations, it may be desirable to configure a WCD to detect the user's geographic position, allow the geographic coordinates to be tagged or annotated with useful information concerning the position and then store the associated information in a central location. The methods and systems may allow other users to easily and quickly retrieve the information for use in real time. The term “real time” is used herein to mean immediately or “in the moment”. If so configured, a WCD may also be able to automatically retrieve and provide information about a location as a user approaches to within a specific distance of the location or it may be retrieved upon request.

As a non-limiting example, such a location may concern a rural southeastern expressway overpass. In the southeastern United States, the temperature rarely falls below freezing. However, when it does, bridges and overpasses tend to develop ice sheets on the span when the roadway on either side of the overpass may not. Such situations are notorious for causing fatal traffic accidents when unwary drivers encounter the ice and lose control of their vehicle. By configuring a WCD according to the subject matter described herein, a police officer or a preceding motorist may recognize the condition, associate the condition to the geographic position of the overpass and store the associated icing information in a central database for dissemination. A subsequent motorist may later approach the overpass and be automatically and effortlessly forewarned by their WCD of the icing condition as they approach the overpass.

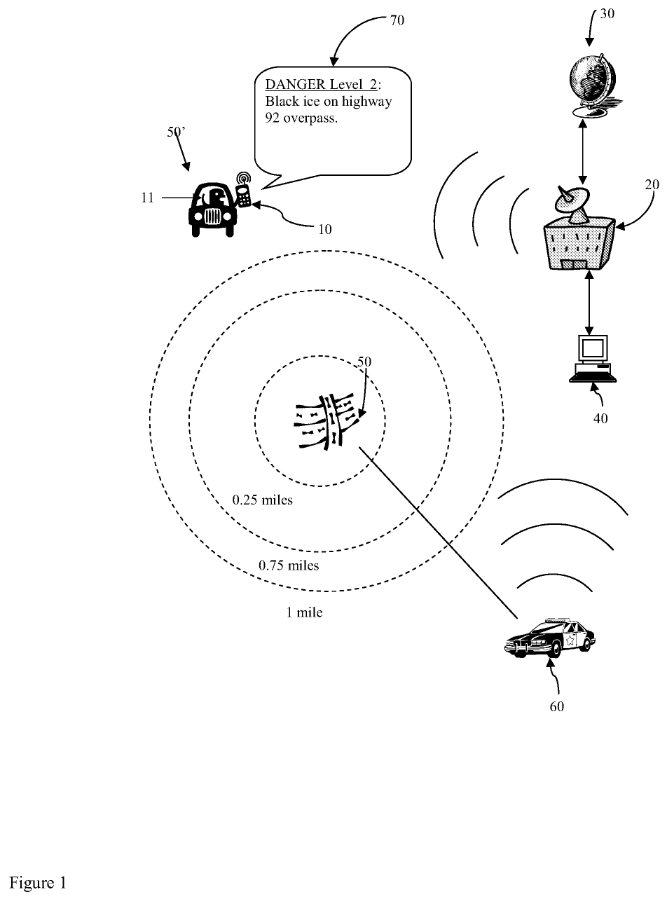

FIG. 1 is an overview of an exemplary system consistent with the disclosure herein using the iced overpass as an illustrative example of a “position” 50. A requesting wireless communication device (“WCD”) 10 may be any type of wireless communication device. Non-limiting examples of the WCD 10 may be a cell phone, a PDA, a pager, a MP3 player, a miniature computer and the like. As a further example, WCD 10 may be a conventional lap top computer with wireless capability. WCD 10 may also include software objects to configure the WCD 10 with Global Positioning System (“GPS”) capability or in the alternative, cellular triangulation capability.

The WCD 10 may be capable of long range communication with a telecommunications system 20. The telecommunications system 20 may be any telecommunications system including a mobile telecommunications system where the user may travel from base station-to-base station or hot spot-to-hot spot. The telecommunications system 20 may be an analog or digital cellular telecommunications system. Moreover, the telecommunications system 20 may be a Personal Communication Service (PCS) in either of its analog and digital versions. The telecommunication system 20 may utilize Time Division Multiple Access (TDMA), Code Division Multiple Access (CDMA), Frequency Division Multiple Access (FDMA) or Global System for Mobile (GSM) technologies. The telecommunication system 20 may also be a satellite communication system and still fall under the purview of this disclosure.

Telecommunication system 20 may include a central server 40 and/or a Geographic Information System (“GIS”) 30. A GIS is a centralized database system containing detailed cartographic and aerial photography information that may be used to augment GPS data as discussed further herein. The central server 40 may store associated information on a plurality of geographic positions, sort the information and transmit the information to a requesting user 11. Central server 40 may also be capable of determining the position of WCD 10 by cellular triangulation or other means should a system design so require.

Continuing with the iced overpass 50 as an exemplary situation, reporting user 60 has identified a dangerous condition at position 50. A reporting user 60 may be a Police unit for example or may be another customer of telecommunications system 20. While at the position 50, reporting user 60 may determine his immediate geographic position which would at that point be collocated with the geographic position of the overpass 50. The reporting user 60 may determine his location using a GPS signal, if the reporting user's reporting WCD (not shown) is configured with a GPS receiver. Alternatively, the reporting user 60 may use cellular triangulation if the reporting user's WCD is so configured. Reporting user 60 may also utilize a keypad or touch pad to manually input the geographic or local map coordinates of position 50 if they are known. If local map coordinates are used, the GIS 30 may assist in converting the local map coordinates to a geographic position using coordinates compatible with telecommunications system 20 such as latitude and longitude, for example.

Once the geographic position of the position 50 is determined, the reporting user 60 may label or “tag” the position 50 with the information of note about the location. Such information may be the icing condition. The information may be part of a graduated scheme. A non-limiting example of a graduated scheme my include such levels such as “Seems Safe”, “Scary”, “Danger Level 1”, “Danger Level 2”, . . . “Danger Level 5—threat to property”, and “Danger Level 6—threat to life and limb”. Tags 70 may take any form or fit any scheme that a system designer may consider useful to convey any information of which a danger level is merely an illustrative example. As a further example, other tags70 or graduated systems may comment on the quality of food served in a restaurant or quality of service at a retail store. “Tagging” electronically associates the information about the location 50 with the geographic coordinates of the location 50. An association may be the inclusion of the geographic position and the information in the same data record, for example.

The reporting user 60 may “tag” the geographic position 50 in any number of ways. As non-limiting examples, tags, such as the tags 70, may be selected from a menu of text phrases or icons displayed on the WCD. Tags may also be created by freeform text or may be assigned to a hotkey for rapid input. Once tagged, the location information is retained in the reporting WCD for fast retrieval and exclusive use by the reporting user. Alternatively, the reporting user 60 may upload the tagged (i.e. associated) location information from the reporting user's WCD to the telecommunication system 20 for storage and general dissemination by central server 40.

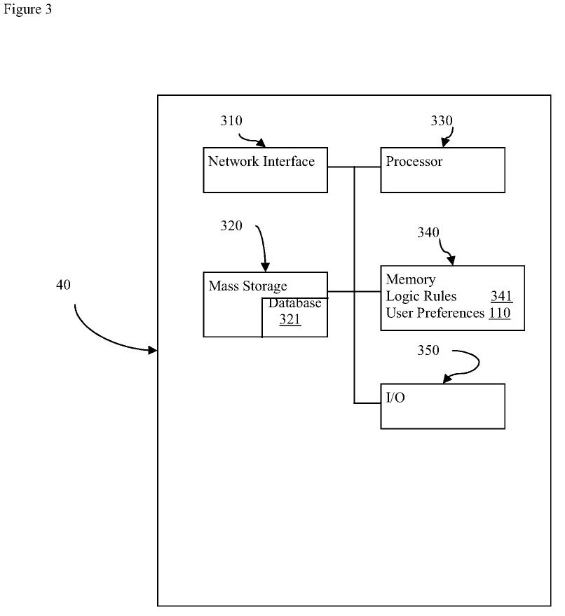

Once the tagged location information has been stored in central server 40, it is available to other user WCDs such as the requesting user 11. The requesting user 11 may configure the requesting WCD 10 to query for tagged information 70 manually, receive it automatically or both. The requesting user 11 may manually request location information about his present position by manipulating one or more keys on a keypad 104 of WCD 10, or if there is a touch screen 105, manipulating the touch screen. Once information is requested, WCD 10 determines its current geographic position 50 and transmits the position data to central server 40. Central server 40 then maps the geographic position to a database of all tags 321 (See FIG. 3) uploaded by reporting user(s) 60 to find those associated with the requested geographic position 50.

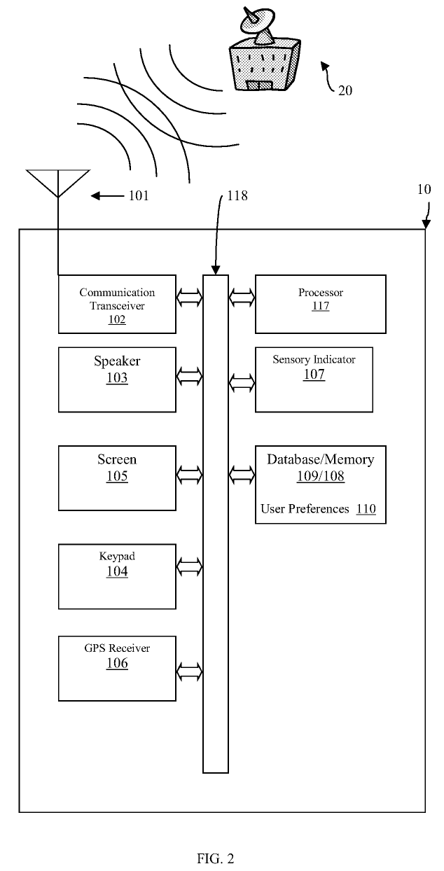

In order to provide only relevant tagged information concerning the requested geographic location 50, the central server 40 may employ a set of logic rules 341 (See FIG. 3) to compensate for input inaccuracies in geographic location data that may be received from multiple reporting user(s) 60. As a non-limiting example of the logic rules 341, central server 40 may transmit to the requesting WCD 10 only those tags 70 associated with the requested geographic coordinates that are located within a certain number of feet of the requested geographic position 50. These logic rules 341 may be determined from a set of user preferences 110 (See FIG. 2) created by the requesting user 11, or the logic rules 341 may be created by the service provider for telecommunications system 20 for efficiency or other operational considerations. The requesting user's preferences 110 may be created and modified by the requesting user via keypad 104 or touch screen 105. The requesting user 11 may also be able to create and modify preferences 110 by accessing a preference web page via the internet. The service provider may create logic rules 341 by accessing central server 40 through an I/O device 350.

In the case where the tagged information is ambiguous, the ambiguity may be resolved in several ways. An office building provides an illustrative, non-limiting example. Because there are several stories of offices at the same geographic position, several offices may receive the same geographic position from a GPS receiver. Many of those separate offices may have an associated tag created by one or more reporting users. Therefore, an ambiguity may arise where a single request for associated information for the single geographic position 50 produces multiple tags 70 for several collocated offices. The ambiguity may be resolved by the central server 40 presenting a list of offices known to be at that position 50. The requesting user 11 may then select the office of interest and receive the appropriate tags 70 associated therewith.

In the case where the central server 40 returns a single location at position 50 with multiple associated tags 70, central server 40 or WCD 10 may numerically average the various tags to present a composite tag for the location. Alternatively, the set of logic rules 341 may reduce the population of associated tags 70. Non-limiting examples of such rules may include filtering the tags by date so that the earliest tags are screened out. Tags may be further screend by “reporting user” where those reporting users that are known to be unreliable are screened out. The list of potential logic rules 341 is endless and may be designed by one of ordinary skill in the art to satisfy a specific user requirement without exceeding the scope of the disclosure herein.

As an additional example, the central server 40 may provide multiple tags 70 associated with the single position 50. As non-limiting examples, WCD 10 may display multiple tags side-by-side. Multiple tags 70 may also be displayed in an expandable hierarchical display where a composite tag may be exploded to display its component tags, or tags 70 may be presented in a simple list.

The requesting user 11 may also configure the WCD 10 to automatically and/or periodically request associated information about his present position 50. In an automatic mode, WCD 10 may periodically query the central server 40 of telecommunications system 20 with its present geographic position 50. The central server 40 may then return the tags 70 associated with the present geographic location 50. The periodicity of the request, along with other user preferences, may be controlled through the requesting user's preferences file 110 as discussed above. Users may stipulate preference data parameters that include any number of characteristics. Non-limiting examples may include time of day, danger level, distance and type of associated information (i.e. danger, food quality, gas station brand, etc.). The types and combinations of preference data 341 are manifold and can be designed to meet any particular design needs of the user 11 without departing from the scope of the disclosure herein. Data screens may also include estimated time of arrival and vector analysis.

In lieu of, or in addition to, the visual display of associated tags discussed above, WCD 10 may include an analog or digital sensory indicator 107. The sensory indicator 107 may be visual (i.e. a progress bar), audible or tactile (i.e. vibration). The sensory indicator 107 allows information to be presented to the requesting user without having to read the associated tags. To provide additional information to the user 11, the intensity of the sensory indicator 107 may vary proportionally to the grade or urgency level of the associated information and/or may vary inversely to the distance from the geographic position 50. The intensity control may be programmed in a variety of ways that may occur to one of ordinary skill in the art and which would not exceed the scope of the disclosure herein.

Returning to the iced overpass example of FIG. 1, the requesting user 11 may have set his requesting WCD 10 to automatic mode while he is driving. In automatic mode, WCD 10 periodically queries the central server 40 for associated information about his then current position 50′. The user preferences 110 for the WCD 10 in automatic mode may request only associated tags 70 for geographic positions within a one mile radius of the WCD 10 for indications of danger. The user preferences 110 may be set to screen out all associated tags for geographic locations within a 270° arc extending from 45° relative on either side of the user's current direction of travel. As the requesting user 11 approaches within one mile of the iced overpass 50, the requesting user 11 may receive a sensory indicator, such as the sensory indicator 107, alerting them of the dangerous situation uploaded by the reporting user 60. The sensory indicator 107 may be a visual progress bar. The sensory indicator 107 may be a variable intensity light, a series of lights or different color lights. The indicator 107 may be a sound, tone, a series of sounds or a sound that changes intensity. Further, preference data screens 341 may be included that screen associated information based on true bearing with, or instead of, relative bearing.

Continuing with the example, the tag 70 associated with the iced overpass may indicate “Danger Level 2”. “Danger Level 2” at a mile distance may trigger a sound or tone of mild intensity. As the requesting WCD/user 10/11 approaches the overpass, the intensity or volume level of the tone may increase. If the requesting WCD/user 10/11 encounters a bend in the road, the overpass 50 may leave the relative sector of interest as the direction of travel changes but may return at the following bend in the road as the direction of travel is restored. The information request periodicity may also be programmed to change as the velocity of the requesting WCD/user 10/11 changes. For instance, the periodicity may shorten as the speed at which the requesting WCD 10 is traveling increases. The periodicity may also change in proportion to the distance the requesting WCD 10 is from the overpass 50. As the requesting WCD/user 10/11 crosses the overpass the sound may become constant with an intensity that may be commensurate with a “Danger Level 2” situation. The example of a dangerous overpass is illustrative only. The same principals may be similarly used with any geographic location such as a restaurant, a theater or a favorite fishing spot in Lake Erie.

FIG. 2 depicts a non-limiting example of the WDC 10 and its components. WCD 10 may include a Radio Frequency (“RF”) transceiver 102 and an associate antenna 101. Transceiver 102 may be capable of communicating wirelessly with telecommunications system 20.

WCD 10 may also include screen 105 and keypad 104. Screen 105 and keypad 104 act as interfaces with the user of WCD 10. Further, WCD 10 may include a GPS receiver 106 from which to obtain the current geographical position of WCD 10. Although the GPS 106 may calculate speed when operating under good conditions and strong satellite signals, intermittent reception can hinder GPS speed measurements. Therefore, it may be useful to include an additional input to determine a position or a parameter such as speed in order to better ensure a satisfactory level of accuracy when the GPS receiver 106 is impaired or ineffective for any reason. Such additional inputs may include cellular triangulation capability.

Geographic positions and any associated information may be saved to a database 109 resident in memory device 108. The memory device 108 may be comprised of any number or types of memory devices that conform to a manufacturer's requirements. Examples of memory devices include magnetic disks, flash memory, memory sticks, Random Access Memory, and Read Only Memory. The list of useful memory devices continues to grow over time and any specific examples mentioned herein are not intended to limit the particular device discussed. The memory 108 may contain other varied information and/or instructions such as the set of user preferences 110.

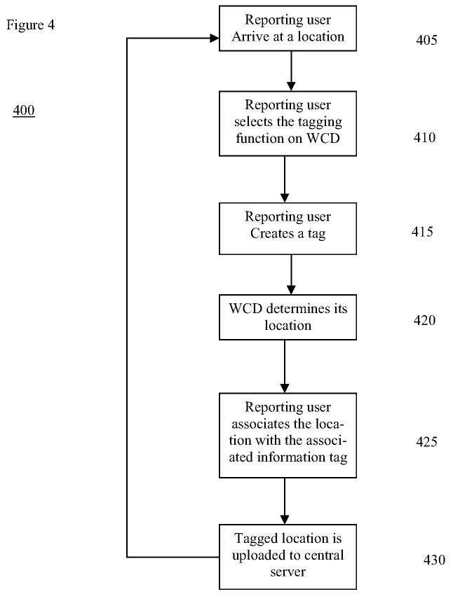

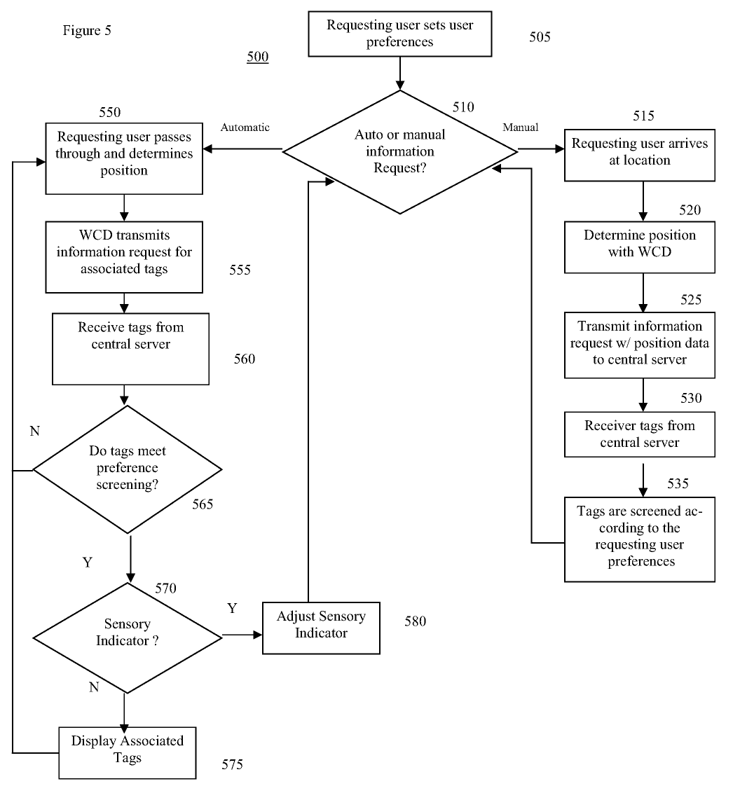

The WCD 10 may have a processor 117 to coordinate the function of its various components. The processor 117 performs actions based on instructions either hard coded into the processor 117 or stored in the memory 108. An example of the logical operations performed is discussed below in relation to FIGS. 4 and 5. The processor 117 and/or memory 108 are examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

Processor 117 may include a central processing unit, an embedded processor, a dedicated/specialized processor (e.g. digital signal processor) or a general purpose programmable processor or some combination. Processor 117 may be any other electronic element responsible for interpretation and execution of instructions, performance of calculations and/or execution of voice recognition protocols. Further the processor 117 may communicate with, control and/or work in concert with other functional components, including at least the transceiver 102, the GPS receiver 106, sensory indicator 107, and the database 109. Communications between and among the processor 117, transceiver 102, the screen 105, the keypad 104, the GPS receiver 106 and other WCD 10 components may be facilitated through a Bus 118. Bus 118 may be comprised of one or a plurality of busses as is desired by a manufacturer.

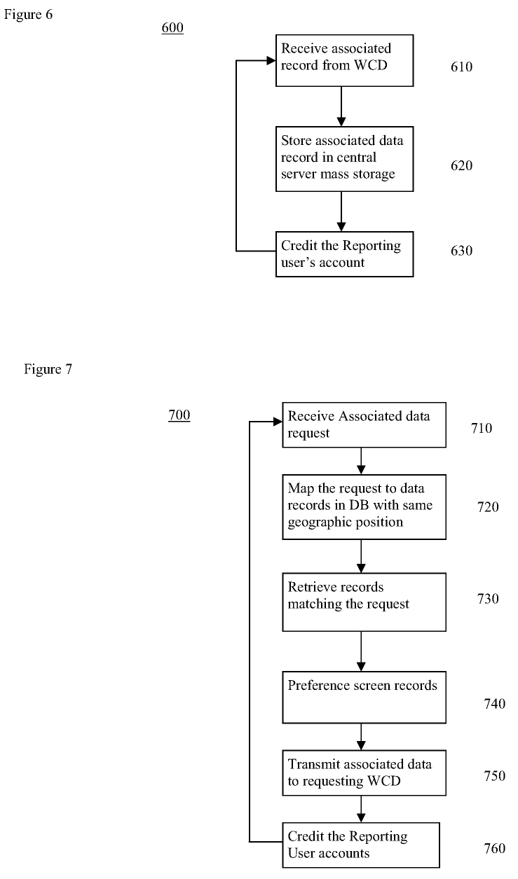

FIG. 3 shows components of an example of the central server 40. The central server 40 may include the standard components of a server computer including a processor 330, memory 340, input/output devices 350, mass storage 320, and a network interface 310. The processor 330 communicates with external devices including requesting WCD 10 and reporting WCD 60 via the network interface 350. The processor 330 may be a single processor, multiple processors or multiple distribute processor and may be a dedicated/special purpose processor or a general purpose programmable processor or some combination. The processor 330 performs actions based on instructions either hard coded into the processor 330 or stored in the memory 340. Processor 330 executes several system functions including receiving associated information from reporting users, storing and collating the associated information, responding to query's for associated information and, if desired, crediting a reporting user's account as associated information is reported and requested. Examples of the logical operations performed by the processor are discussed below in relation to FIGS. 6 and 7.

The memory 340 may be volatile or non-volatile or a combination thereof and may store instructions to be performed by the processor 330 when receiving and sending associated information in addition to the user preferences 110 and logic rules 341. As discussed above in relation to the WCD 10/60, the processor 330 and the memory 340 are examples of computer readable media.

The input/output device 350 may be used for local operation and management of the central server 40. The input/output device 350 may include a keyboard, mouse, display, and the like.

The mass storage device 320 may contain the associated information, logic rules 341, user preferences 110 and/or applications such as an operating system, the location safety indicator service and an accounting system. Thus, the processor 330 may access the storage device 320 when implementing the location safety indicator service. The mass storage device 320 is another example of a computer readable medium.

The database 109 of FIG. 2 may be contained in WDC 10 or it may be contained within the mass storage device 320, or both. Database 109 may be mirrored within the central database 321 that resides within mass storage device 320. As an alternative, the database 321 may be present as network storage, accessible via the network interface 350.

FIG. 4 is a flow chart illustrating an example routine 400 for creating associated tags 70 manually. Being merely exemplary, it should be noted that the processes presented may be combined together, rearranged in their order and split into sub-processes as would occur to one of ordinary skill in the art without departing from the scope of the disclosure presented herein. The routine begins at process 405 where the reporting user 60 arrives at a geographic position 50. The reporting user 60 selects the tagging function on a WCD (not shown) associated with the reporting user 60 at process 410 thereby allowing the reporting user 60 to create an associated tag, such as the tag 70, at process 415. The tag 70 may be created in a number of ways. For example tags 70 may be selected from a predefined menu or may be created with free form text. At process 420, the reporting WCD determines its location by taking a GPS reading, by cellular triangulation or other method. The reporting user 60 then electronically associates the geographic position 50 with the associated information into a data record, such as the tag 70, in process 425. The associated data record 70 is then uploaded from the reporting WCD 60 to the central server 40 for dissemination to requesting users 11 at process 430.

FIG. 5 is a flow chart illustrating an example routine 500 for requesting associated tags 70 automatically. Being merely exemplary, it should be noted that the processes presented may be combined together, rearranged in their order and split into sub-process as would occur to one of ordinary skill in the art without departing from the scope of the disclosure presented herein. The routine begins at process 505 wherein the user 11 sets his/her user preferences 110. As part of the user preferences 110, requesting user's 11 WCD 10 may manually or automatically request tags 70 associated with the location 50. As decision point 510, the WCD 10 determines whether the manual mode or the automatic mode has been selected. If the manual mode is selected then the routine proceeds with process 515 where the requesting user 11 arrives at the geographic position 50. Upon arrival, the requesting user 11 determines his/her geographic position 50 utilizing the WCD 10 at process 520. The requesting WCD 10 may then transmit an information/data request to central server 40 at process 525 which includes the geographic position 50 of the requesting WCD 10. Upon receipt of the data request, the central server 40 retrieves the tags 70 associated with the geographic position 50. The resulting tags 70 are then screened against the set of user preferences 110 at process 530 so that unwanted, irrelevant or inaccurate tags are not transmitted to the requesting WCD/user 10/11. At process 535, the requested tags are displayed to the requesting WCD/user 10/11.

Alternatively, the requesting user 11 may set the WCD 10 to the automatic mode. If so, at decision point 510 the routine would continue to process 550 where the requesting user 11/WCD 10 may pass through and determine the geographic position 50. WCD 10 transmits the geographic position and an associated data request to central server 40 at process 555. After the request is processed at the central server 40 and returned, the resulting tags 70 are received by WCD 10 at process 560. Any resulting tags 70 may be screened against the preset user preferences at process 565. If no tags 70 pass the screening process then the routine returns to process 550 unless the WCD 10 is taken out of automatic mode. It should be noted that the preference screen may take place either before transmitting the tags to WCD 10 while at central server 40 or after. As such, the routine may be altered accordingly. If some tags 70 pass the preference screen, then the tags 70 are displayed to the requesting user 11 at process 575 unless a sensory indicator 107 option had been activated at decision point 570. After the tag is displayed at process 575, the routine returns to process 550 unless the WCD 10 has been changed to a manual mode at decision point 510.

If the sensory indicator 107 has been activated at decision point 570, then the WCD 10 converts the received tag(s) 70 to an electronic signal that drives the sensory indicator 107 at process 580. As discussed above, that indicator 107 may be a sound from speaker 103, a progress bar on screen 105 or a tactile indication such as a vibration. Differing color lights may be used or the WCD screen 105 may alter itself by changing its display or its color. Sensory indicators may vary widely and may include the emission of smoke or a fragrance.

FIG. 6 is a flow chart illustrating an example routine 600 for receiving associated information by central server 40. Being merely exemplary, it should be noted that the processes presented may be combined together, rearranged in their order and split into sub-process as would occur to one of ordinary skill in the art without departing from the scope of the disclosure presented herein. The routine begins at process 610 where information associated with a geographic location is received at the central server 40 from a WCD associated with the reporting user 60. At process 620, the associated data is stored in the database 321 in central server mass storage 320. The associated information may be stored in any manner as is deemed efficient by one of ordinary skill in the art.

To motivate reporting users 60 to tag locations with associated data 70, users may be offered financial or other incentives for participation. Visiting and tagging locations may even become an occupation. An example of an incentive would include crediting an account of the reporting user 60 for each location visited and tagged. This credit may be called a “basic” credit. Incentives may vary by the number of locations tagged during a certain period of time by, accuracy of the associated information and by similar criteria. As such, the process 630 may be optionally included in the routine 600 to provide an incentive for reporting users.

FIG. 7 is a flow chart illustrating an example routine 700 for providing associated information by central server 40. Being merely exemplary, it should be noted that the processes presented may be combined together, rearranged in their order and split into sub-process as would occur to one of ordinary skill in the art without departing from the scope of the disclosure presented herein. The routine begins at process 710 when central server 40 receives a data request. At process 720, the central server 40 maps the geographic position in the request to the associated data records (i.e. tags) 70 stored in mass storage 320. It should be noted that if the request contains a geographic position in a format or coordinate system that is foreign to central server 40, GIS 30 may provide coordinate conversion and other services to central server 40. Central server 40, retrieves the selected associated data records 70 at process 730 and screens them against the requesting user's preference records 110 and/or against the set of system logic rules 341 to maximize operational efficiency at process 740. As non-limiting examples, some logic rules 341 may include data screens eliminating geographic positions within a certain number of yards from the requesting user's home. Another screen example may be to include only those geographic positions within a certain number of feet from the requested position 50. Logic rules 341, data screens and the like are manifold and can be devised in any manner recognized by one of ordinary skill in the art to fulfill a specific purpose.

At process 750, the resulting associated data record(s) 70 are transmitted to the requesting WCD 10 where they are processed according to a method such as that described in FIG. 5. As discussed above in regards to process 630 of FIG. 6, it may be desirable to provide an incentive to reporting users 60 to tag and upload data associated with various geographic positions 50. As an option, reporting users may also be compensated when their tags are down loaded by requesting users, sy process 760. This type of credit may be called a “use” credit. After crediting the account of the reporting user, the routine returns to process 710. Just as in the case of a Basic credit, a Use credit may be monetary or anything of value to the reporting user.

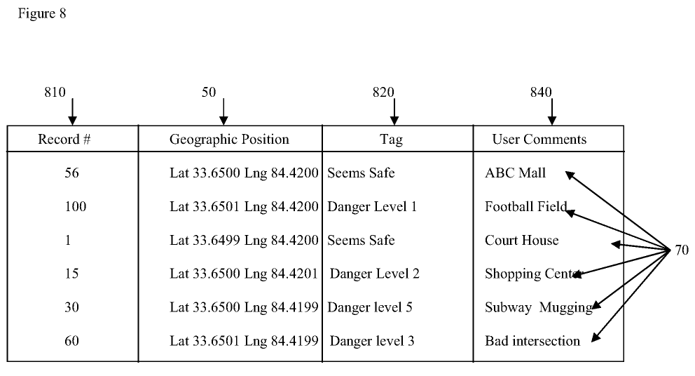

FIG. 8 presents several exemplary associated data records 70 contributed from the reporting user 60 around a general area. The record 70 may include a data record number 810 as is demonstrated in column 810. The data record 70 would include the geographic position 50 where the association was made. The positions illustrated in FIG. 8 are recorded in the decimal equivalent of latitude and longitude. However, geographic position may be recorded in any consistent geographical coordinate system. The data record 70 may include a danger level 820 assigned to the geographic position 50. The data record 70 may also include a reporting user's comments 840 about the geographic position which may be optional. As can be seen from this particular example, the reporting user here has made several data associations. As such they may have received credits concerning any or all of these locations.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for electronically conveying information concerning a geographic position by a first user, comprising:
determining a geographic position of a location with a wireless communication device while present at the geographic position;
receiving information on the wireless communication device via a user interface describing an attribute concerning the geographic position;
electronically associating the information with the geographic position using the wireless communication device; and
uploading the associated information from the wireless communication device to a server within a network for dissemination.

2. The method of claim 1, wherein the mobile communication device uses at least one of triangulation and a Global Positioning System to determine the geographic position.

3. The method of claim 1 wherein the method includes awarding the first user with a first credit for electronically associating and uploading the information.

4. The method of claim 1, wherein the method includes distributing the associated information to a second user in response to a request and in response to the satisfaction of a set of logic rules, wherein the logic rules limit the associated information delivered to the second user.

5. The method of claim 3, wherein the method includes awarding the first user with a second credit based on the downloading of the associated information by the second user.

6. The method of claim 4, wherein if the distributed associated information about the location is ambiguous, resolving the ambiguity by undertaking one of presenting the user with a list of possible locations, presenting a composite of all the associated information concerning a location and displaying multiple presentations of any available associated information concerning a location.

7. The method of claim 4, wherein distributing the associated information includes presenting the second user with a sensory indicator reflecting the nature of the associated information.

8. The method of claim 7, wherein the sensory indicator is a progress bar displayed on a user interface of the wireless communication device

9. The method of claim 7, wherein the sensory indicator is a sound.

10. A central server within a network comprising:
a network interface; and
a processor that sends and receives associated geographic data via the network interface, the processor receives the associated geographic data from a first communication device and sends the associated geographic data to a second communication device upon a query by the second communication device, wherein the associated geographic data includes a geographic position that has been associated with information describing the geographic position by the first communication device.

11. The central server of claim 10, wherein the geographic position was determined by at least one of triangulation and a global positioning system.

12. The central server of claim 10, wherein the information describes an attribute concerning the geographic position from a menu of tag options.

13. The central server of claim 10, wherein the information describes an attribute concerning the geographic position in free text form.

14. The central server of claim 13, wherein the associated information is uploaded to the central server in exchange for a credit to an account belonging to a user of the first mobile communication device.

15. The central server of claim 12, wherein the central server sends the associated information in response to the request by the second communication device after satisfying a set of logic rules limiting the associated information requested.

16. The central server of claim 15, wherein the associated geographical information changes the operation of a sensory indicator so as to reflect the urgency of the associated geographical information.

17. The central server of claim 10 wherein the central server is in communication with a geographical information system which contains cartographical data.

18. A computer readable medium within a mobile communication device containing instructions to:
determine a geographic position of a location using a wireless communication device while present at the location;
receive information via a user interface describing an attribute concerning the geographic position with the wireless communication device;
electronically associate the information with the geographic location by the wireless communication device; and
upload the associated information from the wireless communication device to a server within a network.

19. The computer readable medium of claim 16, wherein the instructions to determine the geographic position include the using one of triangulation and a Global Positioning System to determine that geographic position.

20. The computer readable medium of claim 18, wherein the instructions include distributing the associated information to a second user in response to a request and in response to the satisfaction of a set of logic rules.
